(19) United States
(12) Patent Application Publication
(10) Pub. No.: US 2012/0259842 A1
(43) Pub. Date: Oct. 11, 2012

(54) System and Methods for Targeted Event Detection and Notification

(76) Inventors: Stephen Oman, Dublin (IE); David Moran, Dublin (IE)

(21) Appl. No.: 13/441,293

(22) Filed: Apr. 6, 2012

Related U.S. Application Data
(60) Provisional application No. 61/472,818, filed on Apr. 7, 2011.

(51) Int. Cl. G06F 17/30

(52) U.S. Cl. 707/722; 707/758; 707/E17.045

(57) ABSTRACT

A system and method for targeted event detection and notification based on combinations of time, location and context. A database stores information about users of the system including profile information, and information about real world events such as date, time, and event information. Events are tagged with information that allows searching. A suggestion engine matches particular events to particular users. Events are private (individually), private to groups, and public. A third party such as merchant or advertiser can generate and publish events to users who possess specified profiles. User information is de-identified to address privacy concerns. Users are provided with notifications of events or offers that meet their interest profiles and may accept such events or offers to their calendars, reminder list, timeline or otherwise.

### CROSS-REFERENCE TO RELATED APPLICATIONS

This application claims benefit under 35 U.S.C. §119(e) of U.S. Provisional Patent Application No. 61/472,818, filed Apr. 7, 2011, and entitled “System and Method for Targeted Event Detection and Notification,” which is incorporated herein by reference as if set forth herein in its entirety.

### BACKGROUND OF THE INVENTION

Many people today live a life without a simple way to optimize their time. People want information about events that may be relevant to their personal and business lives. Relevant events can include health, sport, education, commercial offers and finance. Similarly, events relating to family and friend are important—family events, entertainment events, sporting events, education events, network events, etc. are of interest to people. Also, many people wish to share certain information about the events they attend or are interested in with members of their social networks. Therefore, consumers need a lifestyle-based scheduling tool.

Event-based businesses, such as entertainment, hospitality, travel, event promoters, and the like, need an effective, contextualized channel to get their message across in a networked, social world. Further, mobile advertising is exploding—brands and businesses need networked social channels to market their commercial events. The common advertising notion of “spray and pray” is hugely wasteful for the advertising industry—targeted marketing is far more effective. However, some attempts at targeted advertising can encounter privacy roadblocks.

There is thus a need for a system and methods that provide access for event-based businesses to a contextualized cohort of consumers with real and relevant needs and requirements, without compromising privacy and confidentiality concerns, but while providing information about relevant events to persons and others within their social networks.

### BRIEF SUMMARY OF THE INVENTION

Briefly described, and in accordance with certain aspects, the present invention provides a system and methods for contextualized and targeted event detection and notification. The system is a network-accessible application that provides consumers with mobile access to events, allows notifications of relevant events, and allows connection with other members of that consumers social network for sharing of events. Additionally, the system allows for third parties such as merchants, advertiser, sponsors, event promoters, etc. to generate events of possible interest to selected groups of consumers in accordance with consumer's profiles that have been de-identified, and the system communicates such event notifications to selected consumers based on indicated interest profiles without revealing confidential or private information about the consumers to the third parties.

According to one aspect, a system constructed in accordance with the invention links calendar type events with a target audience based on tags, taking into account event location and time. Events are “published” by the system via email, electronic appointment, or otherwise distributed to consumers based on tags and/or location. The system publishes the events to notify consumers; the event organizers do not have direct access to the consumer. Events can be “recommended” to particular users based on meta tags, location, and/or date/time. The system may be constructed as an “add-on” or application that works with conventional calendaring software and with known social networking systems such as Facebook, LinkedIn, Twitter, etc.

According to an aspect, the system allows a view or perspective of a location or a specific event for creation of marketing campaigns. For example, an event organizer or promoter may publish an upcoming event to a group of service providers who provide ancillary services so that these service providers may in turn create related events for subgroups of individuals in narrower subsegments or other market segments. These events can be created in the system or in a third party system and aggregated by the system.

The system allows event viral sharing by consumers of events to “friends” in the known social networking systems. This allows consumers to tell their networking contacts about events and encourage their attendance also.

The system provides capability for various types of pricing models for the system operator, dependent on event location, metatags, weighting, persistence, and duration. Monetization will typically come from pricing various uses of the system to event organizers.

The system has features designed to protect the privacy of consumers and their preferences, i.e. an event organizer will not have direct access to individuals or their specific profiles or their private information; they can only identify market segments (based primarily on tags) of individuals—the system then communicates with the consumers (via via email, electronic appointment, or otherwise) without disclosing the identities to the event organizer

Consumers can search for events of interest to them without disclosing their identity or other information to third parties.

According to one aspect that involves use of a networked computing device, such as a mobile device (e.g. a smartphone), a consumer conducts a search for other members within the consumer's social network. The consumer then creates a connection with such other members in the social network using the system and methods described herein to share events that are relevant to the consumer. The consumer can invite other persons to join the service and participate in notifications as to relevant events. The consumer can also utilize known social networks such as Facebook, LinkedIn, Twitter, etc. to communicate with other members of their social network. The consumer can also follow other users/consumers within the social network to see public events that such other persons have created and/or exposed.

According to one aspect, the system and methods may be used for a consumer to create and manage private events for a select group of members of a social network. For example, a consumer (Alice) may create a birthday party event for a family member, e.g. a brother (Donoghue). This event (e.g. on a Friday at 19:30) would be a private event, and may be free (no third party charges). Alice sends the birthday party event to selected members within her and her brother's social network as a private event. The invitees accept the invitation, and the private event is added to the other members' calendars.

According to an aspect, assume that the brother (Donoghue) is running late to the party. Alice can change the time of the event, e.g. to 20:30. The system provides updated notifications to the selected invitees. According to an aspect, the invitees can be notified by a short message system (SMS) alert.

According to another aspect, the system and methods allow creation and management of private events for groups, e.g. organized groups. Assume that a person (Alice) manages a local hockey team. Alice may create a group of people in the system that are associated with the hockey team. Alice creates an event, e.g. scheduling for a training session Saturday at 10:00 at the Park. This private event is sent to members of the hockey team group. The event contains tags. These tags comprise user-generated descriptions of the event, e.g. #hockey, #sport, #training The system now has information indicating that Alice and other members of the hockey team group are interested in hockey and sports in general, and that such members plan to attend a training session at the Park. According to an aspect, such information can be accessed by third parties, under some circumstances, to send other events and related information to members of the hockey team group, e.g. that a pub near the Park is sponsoring a sports related event near the time of the training session.

According to an aspect, the system and methods described herein can be used to allow such third parties to access information that allow targeted communications to members of a group. such as creating and managing public events. Assume that a third party merchant (Bob) owns a sports equipment shop (Bob's Sports), and that Bob is having a sale on Saturday. Bob may create a public event. That public event may include relevant metatags such as #sport, #sale, #equipment. The system and methods as described herein automatically generate suggestions for consumers participating in the system, based on their interests. For example, Alice and members of the hockey team group have expressed interest in #hockey and #sport via metatags from their private events. According to an aspect, the system creates a public event about Bob's sale, e.g. an event notification about a sale at Bob's Sports on Saturday at 14:00. This public event is sent to persons that have indicated an interest in sports, e.g. via a tag on their events of #sports. In this example, Alice and members of the hockey team group would receive (or be exposed to in a browning experience) the public event notice because they have indicated an interest in sports (#sport metatag). Alice may decide she needs new training shoes and accepts the public event, which is added to her calendar, timeline, reminder list or otherwise.

According to another aspect, the system and methods as described herein can be utilized to provide for payment models for events, purchases, memberships, advertising by third parties, advertisers or sponsors, etc. In one example, a sponsor or advertiser can be charged a one-off fee for an event, e.g. Bob's Sports can be charged $1.00 a day for distribution of a public event (Sale On Bob's Sports—Saturday at 14:00) to a selected group of consumers in the system. In another example, the sponsor or advertiser can be charged for each response to a public notice, e.g. $0.05 for each user that accepts a public event to their calendar. In another example, the sponsor or advertiser can pay for a subscription for a plurality of events in a predetermined time, e.g. Bob's Sports could be charged $50.00 for 50 events per year, or $75.00 for 100 events in a year. In another example, a sponsor or advertiser can bid for event notifications and communication based on relative importance of certain keywords to consumers, e.g. the event “Sale On Bob's Sports—Saturday at 14:00” could be charged a fee of $2.45 per day for communications to consumers identified by predetermined tags such as #sport, #sale, #equipment, etc.

According to another aspect, the system and methods described herein provide tools for searching for events. In an example, assume that a third party, advertiser or sponsor (Charlie) owns a clothes shop C-Boutique. Charlie is having a sale on Tuesday, and creates a public event, e.g. “Sale On C-Boutique—Saturday 14:00”, associated with metatags #fashion, #womens, #sale. Assume that a consumer (Alice) needs a dress for a party. Alice can search the system for events that are relevant and timely to her interests, e.g. by searching for appropriate metatags or keywords. One or more events meeting Alice's search criteria may be returned to Alice for review and response. Alice then inspects the events (i.e. information relating to the event such as date, time, place, nature of event, etc.), and accepts certain desired events to her calendar, timeline or reminder list or otherwise. According to an aspect, the system now has information that Alice is interested in women's fashions. This information may be utilized when generating suggestions for events and tags therefor for other sponsors or advertisers, etc.

According to another aspect, the system and methods described herein provide tools for automated event suggestion. In an example, assume that a consumer (Alice) has a predetermined set of interests as reflected by certain tags and/or or keywords associated with a profile for Alice that is stored in the system. The system assigns a weighting based on how much interest the consumer (Alice) shows based a number of events that Alice has viewed and/or accepted. The system also has information as to locations frequented by Alice. For example, tags and weightings for Alice might be as follows: #hockey—5, #sport—6, #training—5, #sale—2, #equipment—2, #fashion—1, #womens—1. For example, locations for Alice might be as follows: The Park, Bob's Sports, C-Boutique. According to an aspect, the system automatically generates suggestions for consumers based on their interests and locations, e.g. an event corresponding to Bob's sale (Sale on Bob's Sports—Saturday 14:00) or Charlies' fashions (Sale On C-Boutique—Saturday 14:00). Such suggestions may take the form of public events sent to predetermined groups of consumers identified by the system. According to another aspect, the system and methods as described herein may provide for creation and management of trip events. In one example, assume that a consumer (Alice) is taking a trip to New York. Alice creates a trip event in the system that will change her location for a specified period. In this example, Alice's profile of location information may include an entry indicating Alice is in New York from Thursday to Sunday. In this example, the system automatically creates additional suggestions for the Alice based on her profile of interests (#fashion, #womens, etc.) and provides for new events that may be of interest, e.g. “Sale On Macy's—Saturday 14:00” or “Sale On Barney's—Saturday 14:00”.

According to aspects of the invention, a system and method constructed in accordance with the invention is operative to provide for, including but not limited to: (1) event publication to users based on meta-tags and/or Location, (2) recommendation of events to users based on meta-tags and/or location and/or date/time. (3) location-specific event inclusion in a social network site, (4) event timeline sharing to members of a social network, (5) variability and flexibility in pricing models, dependent on event location, meta-tag weightings and duration, and (6) privacy, i.e. provides the ability for consumers to discover events without disclosing private data to third parties such as advertisers or sponsors.

According to further aspects of the invention, systems and methods as described herein relate to detection of “events” that occur at a place and time that people may be interested in attending, and notifying a set of people who have indicated an interest in such events of the upcoming event, typically by mechanisms designed to insert electronic appointments of the event into electronic calendars, e.g. via Outlook, Google calendars, etc. Consumers are enabled to search for and find events of interest to them and have them appear on their electronic calendars, and/or to be selectively notified of events of interest to them.

The system has particular utility as a targeted marketing system for communicating event information to a set of de-identified individuals who have expressed an interest in certain types of events by subject matter, time, interest level, affinity, etc. Event organizers (e.g. merchants who are putting on a sale, entertainment venue operators who are bringing an act into town, etc.) have access to the system to (a) construct marketing campaigns to select a set of individuals (de-identified) having particular demographics, and (b) trigger communication with such individuals through the system to provide information about the events. These communications typically take the form of “appointments” that can be accepted onto an individual's electronic calendar.

The system is computer-implemented and typically involves consumers (prospective event attendees or marketing targets) using their Internet-connected computer systems and/or mobile devices such as smartphones, and event organizers (merchants, venue operators, meeting arrangers, travel agents, etc.) that create, sponsor, and/or run events. The primary databases and informational entities involved include the following:

a) consumers/event users—who provide information as to preferences and interests, and typically have one or more electronic calendars.

b) event organizers/merchants—who create marketing campaigns constructed around events that occur at particular times and places (i.e. events are typically time and/or geography delimited).

c) events—information relating to particular occurrences in time and location, identified by various properties such as qualifications to attend, tags, features of the event, benefits of the event, entertainers or other draws to an event, etc. Events may also include concerts, exhibitions, product launches, conferences, sales and also includes consumer offers that must be redeemed in a certain place and during a certain time. These redemptions can be with or without coupons.

d) tags—specific, particular information about events and their characteristics that allow a matching operation between consumers who have expressed interests as reflected in a personal profile and event organizers who are looking to send targeted communications to selected individuals based on tags that are associated with consumers.

e) location/time and date—because all events are time and location-specific, this data is key to determining the existence of a discrete event.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

FIG. 1 is a block diagram illustrating aspects of a computer-implemented system constructed in accordance with aspects of the invention(s), that effects methods in accordance with aspects of the invention(s).

FIG. 2 is a diagram that provides an overview of a system constructed in accordance with aspects of the invention(s).

FIG. 3 is a sequence diagram illustrating a process for operation of a system and methods in accordance with an aspect of the invention(s).

FIG. 4 illustrates aspects of the data schemas or designs for data items for use in a system and methods in accordance with an aspect of the invention(s).

FIG. 5 is a table of data items, data fields, and data descriptions for data used in a system and methods in accordance with an aspect of the invention(s).

FIG. 6 is a sample implementation of a user interface on a smartphone, illustrating the user's own events, described in a traditional calendar format, in accordance with aspects of the invention(s).

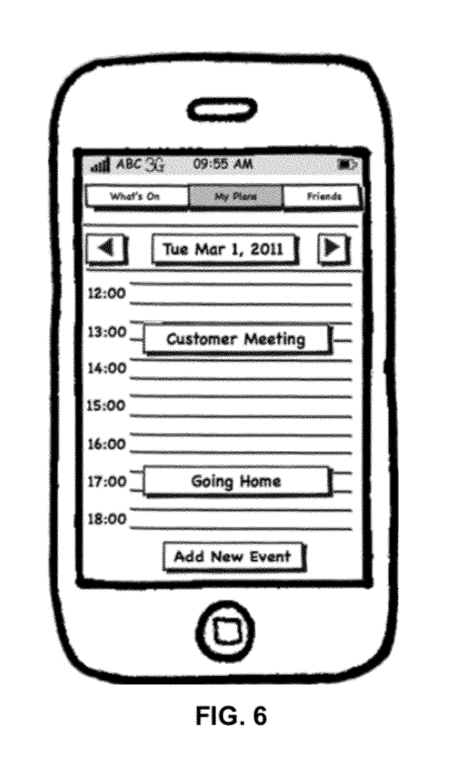

FIG. 7 is a sample implementation of a user interface on a smartphone, illustrating the data-capture mechanism, which contains the crucial time, location and description data, in accordance with an aspect of the invention(s).

FIG. 8 is a sample implementation of a user interface on a smartphone, illustrating an example view of the output from the invention as it pertains to a single user. Other users would necessarily see different data in accordance with aspects of the invention(s).

### DETAILED DESCRIPTION OF THE INVENTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

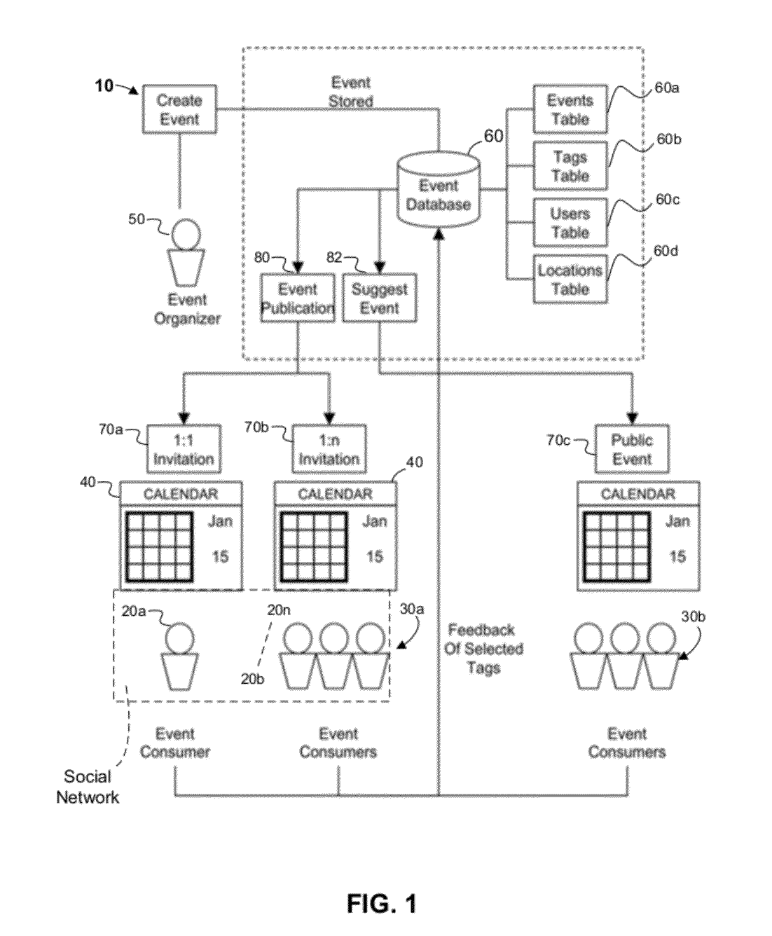

FIG. 1 is a block diagram of a system 10 constructed in accordance with aspects of the invention(s) that provides for targeted event detection and notification. The system 10 is computer network accessible by a plurality of users or consumers 20a, 20b, . . . 20n who use the system. A plurality of consumers 20 may constitute a group 30. Each consumer uses a computing device (not shown), such as a mobile phone or smartphone, laptop computer, etc. (not shown) to access his or her computer-based calendars 40. Such calendars may be provided by an operator of the system 10, or may be provided by other calendar based software such as Google Calendar, Microsoft Outlook, Apple Calendars, etc.

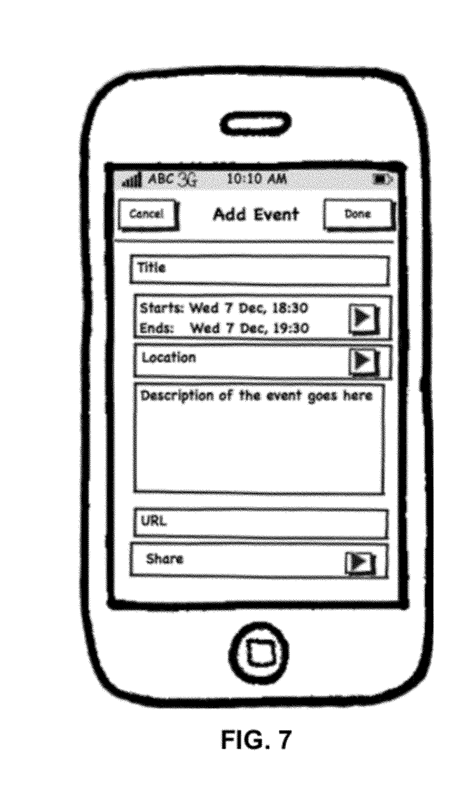

An event organizer 50 may create and publish public events to selected (targeted) consumers 20 or groups 30 of consumers. Likewise a consumer 20a can create and publish private events to selected consumers or groups 30 of consumers. FIG. 7 shows such an implementation on a smartphone. The system 10 comprises a network-accessible computer system that includes an event database 60, which includes an events table 60a, a tags table 60b, a users table 60c, and a locations table 60d. The system 10 comprises software that accesses the database to create data items, update data items, retrieve data items, etc., to carry out various computer-implemented processes for creating, editing, distributing, and responding to events. The system 10 creates events 70 of various types or species which are distributed to consumers. Such events are typically in the form of calendar invitations or appointments consistent with known calendar formats such at Microsoft Outlook, Google Calendars, Apple

Calendar, etc. A private 1:1 invitation 70a is an event directed to a particular consumer e.g. 20a. A private 1:n invitation 70b is an event directed to a selected plurality or group 30a of consumers, e.g. to a social network consumers in a group 30a that is associated with the consumer 20a. A public event 70c is similarly directed to a selected plurality of group 30b of consumers that have predetermined characteristics or attributes in common.

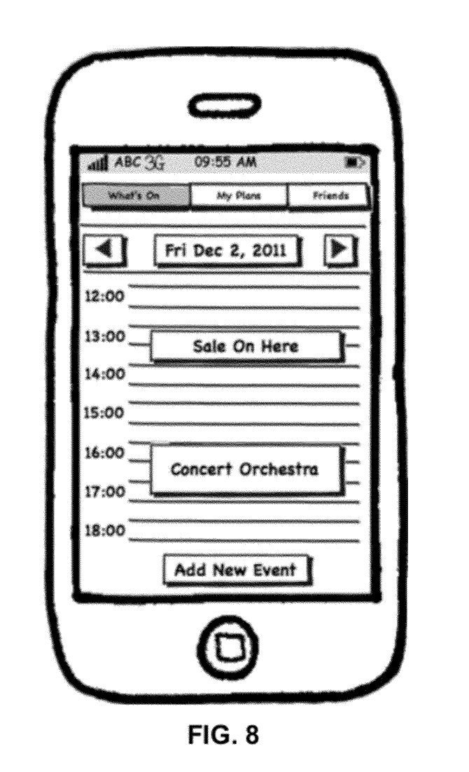

The system 10 publishes events, e.g. at 80 to selected consumers 20. The system also suggests events, e.g. at 82 to selected consumers in a group 30b that have attributes or characteristics in common. FIG. 8 shows a sample implementation of the user interface for a user on a smartphone, illustrating the published events for that user.

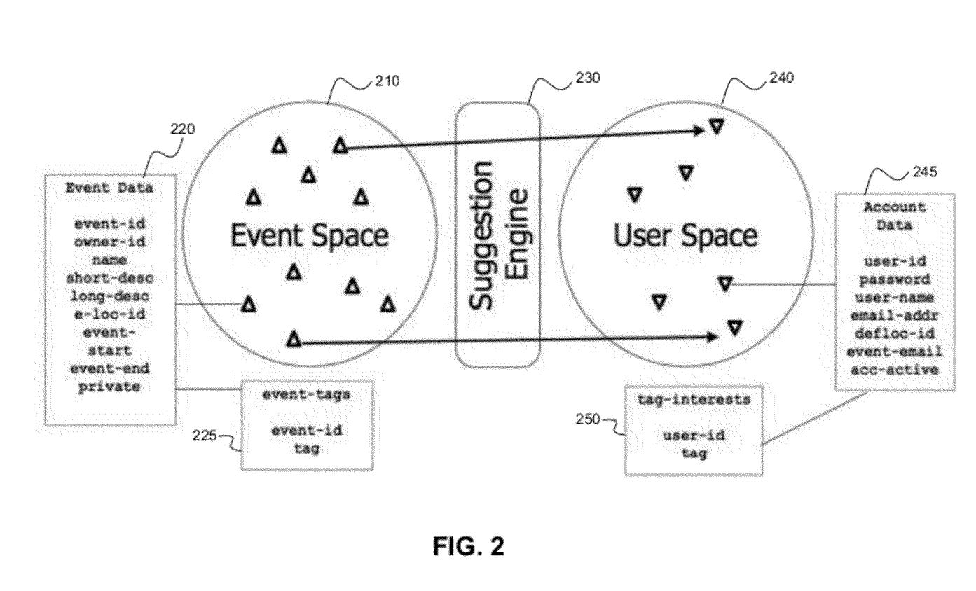

FIG. 2 provides an overview of the operations of the system 10. Conceptually, events comprise specific event information items that are created and stored in an event space database 210. This event information comprises event data 220 that is created and stored in the system 10 for each event, in the event database 60 (FIG. 1). Such event data comprises, for example: event-id (an event identifier), owner-id (an owner of the event), name (a name for the event), short-desc (a short description of the event), long-desc (a longer description of the event), e-loc-id (a location identifier for the event), event-start (a starting date and time for the event), event-end (an ending date and time for the event), and private (i.e. whether public or private). Also provided are event tags that allow profiling of an event; such data is also created and stored in the database 60 in association with events. The event tag information includes an event-id (event identifier), and one or more tags of specific information in a predetermined tag format (not shown).

A suggestion engine 230, provided as software for the system 10, accesses information about the events from the event data 220 and tags 225, and maps that data into a user space database 240. The user space 240 comprises data associated with users or consumers 20 as user information 245. User information 245 is stored in the system 10 in the database 60. User information 245 includes Account Data such as: user-id (a user identifier for each user or consumer), password (for security), user-name (a name for the user), email-addr (email address information for the user), defloc-id (a default location for a user), event-email (an email address associated with an event), acc-active (a flag indicating activity of an account for a user).

Also stored in the system 10 in association with users are tags 250 corresponding to user interests. For example, tag-interests (tag or keyword(s) associated with particular interests of a user), user-id (user identifier), and tag (specific tags).

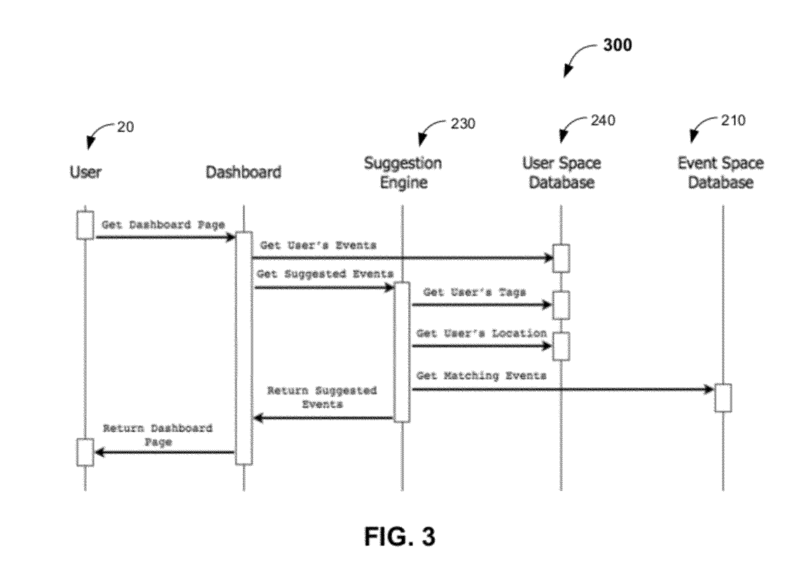

FIG. 3 is a sequence diagram showing the steps of a method 300 carried out by the computer-implemented suggestion engine 230, by communications between the various entities involved in operations of the system 10 including user (or consumer) 20, a dashboard or user interface for a computing device used by the user, the suggestion engine 230, the user space database 240, and the event space database 210.

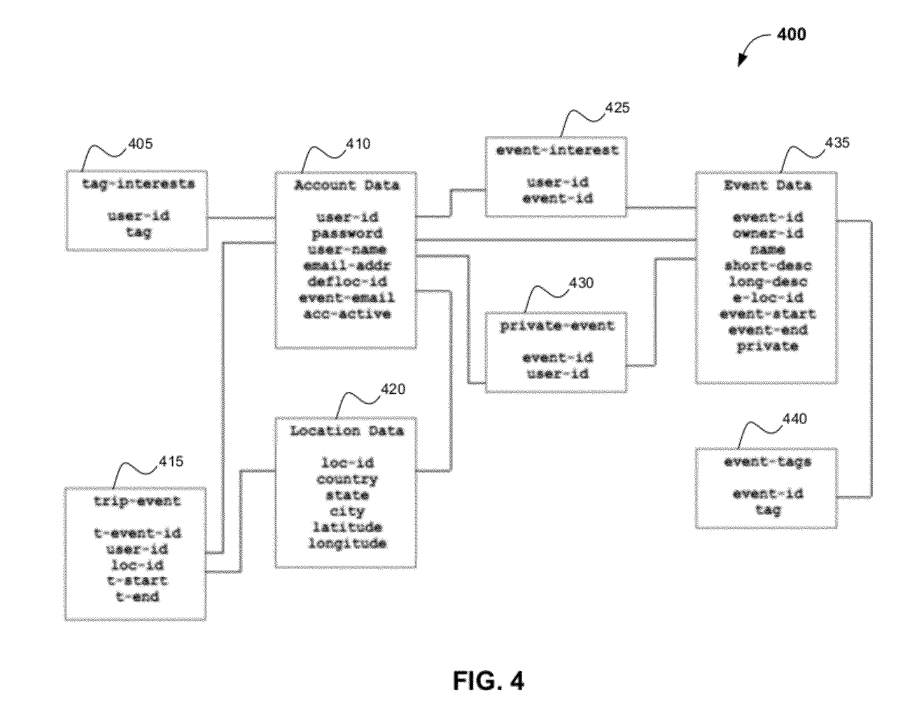

FIG. 4 illustrates details of the data items and data design for various data tables 400 of the database 60. In accordance with aspects of the invention, the data items include data tables in the database 60 including a tag-interests table 405, an account data table 410, a trip event table 415, a location table 420, an event interests table 425, a private event table 430, a event data table 435, and a event tags table 440. Various data items in such tables are shown in the diagram.

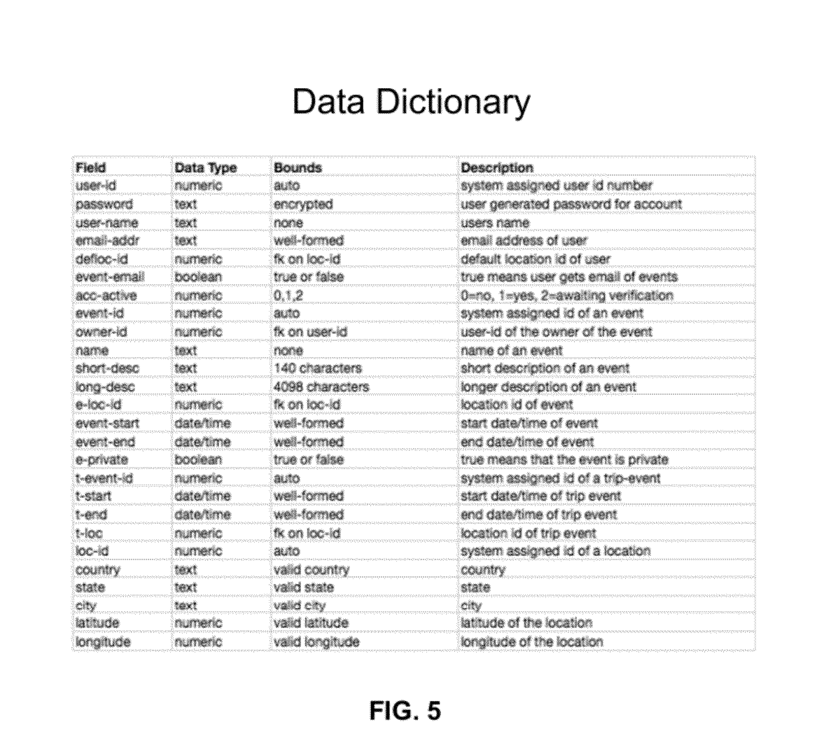

FIG. 5 is a data dictionary that provides further details of the various data items, fields, identifiers, tags, etc. as shown in the above diagrams. Such details are self-explanatory and will be understood by those skilled in the art.

As will be understood by those skilled in the art, the sequence diagram of FIG. 3 depicts key processes in operations of a system 10 constructed in accordance with aspects of the invention. It will be understood that aspects of the invention are implemented as computer program processes and/or modules and/or programs that execute on general purpose computers operated by an operator of the system 10. FIG. 1 illustrates an example of a suitable networked computing system environment on which embodiments may be implemented. The networked computing system environment is only one example of a suitable computing environment and is not intended to suggest any limitation as to the scope of use or functionality of the claimed subject matter. Neither should the computing environment be interpreted as having any dependency or requirement relating to any one or combination of components illustrated in the exemplary operating environment.

Although aspects of the invention(s) are shown as computer-implemented processes, occurring in a particular order or sequence, and on occasion with seemingly sequential numbering or identification in the drawings, it should be understood that in many instances there is no required ordering or sequencing of certain processes or steps or operations, except when certain processes or steps or operations require the results of a temporally-earlier process or step or operation in order for its function to occur. Many computer operations are asynchronous in nature, many operate in endless loops awaiting a particular input or stimulus, and many operate in response to receiving a message or being passed a parameter or provided with an input or stimulus. Thus, no ordering or sequencing should be imposed on the claimed inventions except where necessary and required due to the need for a prior temporal operation. Generally, therefore, the invention(s) and their aspects should be interpreted as not limited to a particular ordering or sequence.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Embodiments as described herein are designed to be practiced in distributed computing environments where tasks are performed by remote processing devices that are linked through a communications network. In a distributed computing environment, program modules are located in both local and remote computer storage media including memory storage devices.

An exemplary system for implementing some embodiments includes a general-purpose computing device in the form of one or more computers or servers. Components of such computers or servers may include, but are not limited to, a processing unit, a system memory, and a system bus that couples various system components including the system memory to the processing unit. The system bus may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computers and servers typically include and utilize a variety of computer readable media. Computer readable media can be any available media that can be accessed by the computer or server and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory for a computer or server includes computer storage media in the form of volatile and/or nonvolatile memory such as read only memory (ROM) and random access memory (RAM). A basic input/output system (BIOS), containing the basic routines that help to transfer information between elements within computer or server, such as during start-up, is typically stored in ROM. RAM typically contains data and/or program modules that are immediately accessible to and/or presently being operated on by a processing unit in the computer or server. By way of example, and not limitation, a computer utilized in constructing the system 10 includes an operating system, application programs, other program modules, and program data.

The computer or server may also include other removable/non-removable volatile/nonvolatile computer storage media. By way of example only, each computer or server may include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. A hard disk drive is typically connected to the system bus through a non-removable memory interface, and any magnetic disk drive and/or optical disk drive are typically connected to the system bus by a removable memory interface.

The drives and their associated computer storage media discussed above provide storage of computer readable instructions, data structures, program modules and other data for the computer or server. As is known to those skilled in the art, a hard disk drive typically stores an operating system, application programs, other program modules, and program data.

A user such as an end user may enter commands and information into his or her computer through input devices such as a keyboard, a microphone, and/or a pointing device such as a mouse, trackball, touch sensitive screen, or touch pad (not shown). Other input devices may include a joystick, game pad, satellite dish, scanner, or the like. These and other input devices are often connected to the processing unit of the computer through a user input interface that is coupled to the system bus, but may be connected by other interface and bus structures, such as a parallel port, game port or a universal serial bus (USB). A monitor or other type of display device (not shown) is also connected to the system bus via an interface, such as a video interface. In addition to the monitor, computers may also include other peripheral output devices such as speakers and printer, which may be connected through an output peripheral interface.

The computer of the system 10 is typically operated in a networked environment using logical connections to remotely located computers or mobile devices associated with consumers 20. Any remote computer or other device may be a personal computer, a hand-held device, smartphone, a server, a router, a network PC, a peer device or other common network node, and typically includes many or all of the elements described above relative to the computer. The logical connections depicted in FIG. 1 include a local area network (LAN) and a wide area network (WAN), but may also include other networks. Such networking environments are commonplace in offices, enterprise-wide computer networks, intranets and the Internet.

When used in a LAN networking environment, a computer or server is connected to the LAN through a network interface or adapter. When used in a WAN networking environment, the computer typically includes a modem or other means for establishing communications over the WAN, such as the Internet. The modem, which may be internal or external, may be connected to the system bus via the user input interface, or other appropriate mechanism. In a networked environment, program modules depicted relative to the computer, or portions thereof, may be stored in the remote memory storage device. It will be appreciated that the network connections shown are exemplary and other means of establishing a communications link between the computers may be used.

The foregoing description of the exemplary embodiments has been presented only for the purposes of illustration and description and is not intended to be exhaustive or to limit the inventions to the precise forms disclosed. Many modifications and variations are possible in light of the above teaching.

The embodiments were chosen and described in order to explain the principles of the inventions and their practical application so as to enable others skilled in the art to utilize the inventions and various embodiments and with various modifications as are suited to the particular use contemplated. Alternative embodiments will become apparent to those skilled in the art to which the present inventions pertain without departing from their spirit and scope. Accordingly, the scope of the present inventions is defined by the appended claims rather than the foregoing description and the exemplary embodiments described therein.

What is claimed is:

1. A system that suggests relevant real world events to users comprising:
a repository of information about the users of the system;
a repository of information about real world events; and
a suggestion engine that matches the events to the users.

2. The system of claim 1, wherein the suggestion engine matches real world events to users based on location or a combination of location and time thereby suggesting events that are location-relevant comprising:
a repository of location tags corresponding to real world locations;
a subset of the location tags for events that the user has created and their corresponding weightings;
a subset of the location tags for the events that the user has viewed and their corresponding weightings;
a subset of the location tags for events that the user has accepted and their corresponding weightings;
a subset of the location tags for events that the user has rejected and their associated weightings;
a suggestion engine that filters the real world events created by one user by the time the event occurs, location tags and location tag weightings of a second user; and
an interface to display the resulting filtered list of real worlds event to the second user.

3. The system of claim 1, wherein the suggestion engine matches real world events to users based on meta-tags, thereby suggesting events that are context-relevant comprising:
a repository of meta-tags corresponding to user-generated tagging information consisting of words, images, sounds or other media;
a subset of the meta-tags associated with real world events that the user has created and their corresponding weightings;
a subset of the meta-tags associated with events that user has viewed and their corresponding weightings;
a subset of the meta-tags associated with events that the user has accepted and their corresponding weightings;
a subset of the meta-tags associated with events that the user has rejected and their corresponding weightings;
a suggestion engine that filters the real world events created by one user by the meta-tags and meta-tag weightings of a second user; and
an interface to display the resulting filtered list of real worlds event to the second user.

4. The system of claim 1, wherein the suggestion engine suggests events that are both location-relevant and context-relevant.

5. The system of claim 1, further comprising:
personally identifiable information including a username and password, a contact email address, a default location, a list of users who they have shared their event timeline with.

6. The system of claim 1, further comprising:
a repository of event related data, corresponding to user-generated data appended to an event, either before the event occurs or after the event occurs, containing information consisting of words, images, sounds or other media, relating to comments or other event related information that users can associate with an event in the event repository.

7. The system of claim 2, wherein:
a repository of location tags, where the locations correspond to physical locations, are designated by latitude and longitude, or designated by common place names, or other information which is used to pinpoint a location in space.

8. The system of claim 1, wherein the repository of information relating to real world events comprises:
a repository of events, where some events correspond to occurrences at a particular point in time, at a particular location, attended by a specific list of invited users (a private event), and other events correspond to occurrences at a particular point in time, at a particular location without a specific list of invited users (a public event).

9. The system of claim 2, wherein the weightings associated with the subsets of locations tags are based on combinations of views, accepts and rejects of events comprising:
a persistent storage element comprising a set of system generated event location tags associated with public and private events;
a persistent storage element that associates a subset of the set of system generated event location tags with a user; a persistent storage element that contains the aggregate number of private events that a user has created or viewed which contain a system generated event location tag in the associated subset of system generated event location tags;
a persistent storage element that contains the aggregate number of public events that a user has created or viewed which contain a system generated event location tag in the associated subset of system generated event location tags;
a persistent storage element that contains the aggregate number of private events that a user has accepted into their timeline which contain a system generated event location tag in the associated subset of system generated event location tags;
a persistent storage element that contains the aggregate number of public events that a user has accepted into their timeline which contain a system generated event location tag in the associated subset of system generated event location tag;
a persistent storage element that contains the aggregate number of private events that a user has rejected from their timeline which contain a system generated event location tag in the associated subset of system generated event location tags;
a persistent storage element that contains the aggregate number of public events that a user has rejected from their timeline which contain a system generated event location tag in the associated subset of system generated event location tags;
persistent storage elements for each of the above aggregate numbers, containing a fractional value of the aggregate total representing the recentness of the last event creation, view, acceptance or rejection, such that more recent actions have a higher fractional value compared to less recent actions;
a computer implemented method of calculating a weighting value against each system generated event location tag in the subset of system generated event location tags associated with the user; and
a computer implemented method of calculating the closeness of a newly created event to a user using the composite of weightings in the subset of system generated event location tags associated with the user.

10. The system of claim 3, wherein the weightings associated with the subsets of meta-tags are based on combinations of views, accepts and rejects of events comprising:
a persistent storage element comprising a set of user generated event tags associated with public and private events;
a persistent storage element that associates a subset of the set of user generated event tags with a user;
a persistent storage element that contains the aggregate number of private events that a user has created or viewed which contain a user generated event tag in the associated subset of user generated event tags;
a persistent storage element that contains the aggregate number of public events that a user has created or viewed which contain a user generated event tag in the associated subset of user generated event tags;
a persistent storage element that contains the aggregate number of private events that a user has accepted into their timeline which contain a user generated event tag in the associated subset of user generated event tags;
a persistent storage element that contains the aggregate number of public events that a user has accepted into their timeline which contain a user generated event tag in the associated subset of user generated event tags;
a persistent storage element that contains the aggregate number of private events that a user has rejected from their timeline which contain a user generated event tag in the associated subset of user generated event tags;
a persistent storage element that contains the aggregate number of public events that a user has rejected from their timeline which contain a user generated event tag in the associated subset of user generated event tags;
persistent storage elements for each of the above aggregate numbers, containing a fractional value of the aggregate total representing the recentness of the last event creation, view, acceptance or rejection, such that more recent actions have a higher fractional value compared to less recent actions;
a computer implemented method of calculating a weighting value against each user generated event tag in the subset of user generated event tags associated with the user; and
a computer implemented method of calculating the closeness of a newly created event to a user using the composite of weightings in the subset of user generated event tags associated with the user.

11. The system of claim 3, further comprising a synonym repository for meta-tags, whereby meta-tags with different spellings and interpretations are mapped together to a single underlying synonym for matching.

12. The system of claim 1, where the synonym repository for tags in claim 11 is used to further enhance the breath of recommendations generated.

13. The system of claim 1, further comprising:
an interactive system that comprises one or more server components that are remotely accessible by users via a network, using an end-user computing device either wired or wireless or mobile.

14. A computer system of claim 13, wherein the communication protocol between the said end-user computing devices and the server components comprises:
a series of http requests from an Internet browser application running on the end-user computing device and the server components, with the responses in the form of web pages coded in HTML; and
a series of http requests from an application running the end-user computing device and the server components, with the responses in the form of XML encoded data.

15. A computer system of claim 1, allowing a user to publish their timeline to third party social networking sites, using the published APIs available in that third party site.

16. The system of claim 8, further comprising:
a pricing engine that allows a user creating a public event to set user generated price points for the composite user generated event tags they associate with their event.

17. The system of claim 16, wherein the pricing engine comprises:
a repository of tag prices, associated with the repository of tags;
an interface allowing the user to set a price for an individual user generated event tag they associate with their public event;
an interface allowing the user to set a multiple of price points for a set of user generated event tags they associate with their public event;
an interface allowing the user to set a price for an individual system generated event location tag associated with their public event;
an interface allowing the user to set a price for a specific time period their event is scheduled for;
an interface allowing the user to set a price proportional to the length of time between the creation of the event and the scheduled start date and time of the event;
an interface allowing the user to view the minimum, maximum and average price points of user generated event tags set by other users creating public events;
an interface allowing the user to view the minimum, maximum and average price points of system generated event location tags set by other users creating public events;
a service to calculate the likely cost to the user of creating and publishing a public event based on the inputs supplied through the interfaces and the current price points submitted by other users on the same set or subset of user generated event tags and or system generated location tags.

18. The system of claim 16, wherein the ranking the suggested events is based on the price points calculated by the pricing engine.

19. A computer system for targeted event detection and notification, comprising:
an interface to allow a user to view their timeline, the timeline being a list of all the events and offers that they have in their Event List and their calendar, in a chronological order;
an interface to allow a user to upload events created in a third party calendar management application to the current invented system;
an interface to allow a user to download events from the current invented system to a third party calendar management system;
an interface to allow a user to display their timeline, or a subset of their timeline bounded by time or by tags or by locations or by other event data or event related data, in a third party application or third party website;
an interface to allow a user create and manage private events, including functions to designate the title of the event, the location of the event, the start date and time of the event, the end date and time of the event, additional descriptive elements of the event including but not limited to text, images, sounds and maps, a list of users who are invited to the event, a list of users who may view the event in a timeline and a list of user generated tags that describe the context of the event;
an interface to allow a user create and manage public events, including functions to designate the title of the event, the location of the event, the start date and time of the event, the end date and time of the event, additional descriptive elements of the event including but not limited to text, images, sounds and maps, and a list of the user generated tags that describe the context of the event;
an interface to allow a users to invite other users to an event, where that user is not the original creator of the event, but is an invitee;
an interface to allow a user to view other users' private events that they have been invited to;
an interface to allow a user to accept an event that the user has been invited to, where it is added to the user's timeline;
an interface to allow a user to search the events repository, using search terms corresponding to the title of an event, the location of an event, a bounding time period for an event, event tags attached to an event, limited to events that that user has created or has been invited to, or to public events, regardless of the original creator;
an interface to allow the creator of a private event to view the list of users that have accepted the event into their timeline or have rejected the event from their timeline;
an interface to allow the creator of a public event to view aggregate totals of users that have viewed the event, aggregate totals of users that have accepted the event, aggregate totals of users that have rejected the event, aggregate totals of users by location that have viewed the event, aggregated totals of users by location that have accepted the event, aggregated totals of users by location that have rejected the event;
an interface to allow a user to browse and manage the event tags that have been associated with that user;
an interface to allow a user to create a trip event, corresponding to an event in the physical world that the user plans to change location, including functions to designate the title of the event, the location of the event, the start date and time of the event, the end date and time of the event, additional descriptive elements of the event including but not limited to text, images, sounds and maps, and a list of the user generated tags that describe the context of the event;
an interface that allows a user to share an event with another user or set of users, where that user or set of users can view the event, and see its occurrence on their timeline; and
an interface that allows a user to share their timeline with another user or set of users.

20. A system and methods that provide for targeted event detection and notification, comprising:
a service that associates event tags and or location tags with a user when the user creates, views, accepts and or rejects an event;
a service that calculates the weightings for the event tags associated with a user;
a service that calculates the weightings for the location tags associated with a user;
a service that generates recommendations for events for a user based on the corresponding event tags and location tags and their associated weightings, and or the location of the user, and or the location of the user during a trip event, and or the current physical location of the user;
a service that sends a notification to a user of an event or events that appear in the recommendations generated by the recommendation service, via a notification channel selected by the user, including but not limited to postal mail, email, Short Message Service (SMS), Multi-Media Message Service (MMS);
a service that generates a charging event for the creator of a public event upon another user viewing that event;
a service that generates a charging event for the creator of a public event upon another user accepting that event; and
a service that generates a charging event for the creator of a public event upon information about that event being displayed to a user, regardless of the appropriateness of that event for the viewing user based on the event tags or location tags matching.
